(19) United States
(12) Patent Application Publication
(10) Pub. No.: US 2023/0097808 A1
(43) Pub. Date: Mar. 30, 2023

(54) CHIP PARTS

(71) Applicant: ROHM CO., LTD., Kyoto (JP)

(72) Inventor: Keisuke FUKAE, Kyoto (JP)

(73) Assignee: ROHM CO., LTD., Kyoto (JP)

(21) Appl. No.: 17/943,610

(22) Filed: Sep. 13, 2022

(30) Foreign Application Priority Data
Sep. 29, 2021 (JP) 2021-160043

(51) Int. Cl. H01L 23/00; H01L 49/02

(52) U.S. Cl. CPC H01L 24/48; H01L 28/90; H01L 2224/48265; H01L 2924/19041; H01L 2924/19104

(57) ABSTRACT

The present disclosure provides a chip part. The chip part is capable of ensuring a greater capacitance of a capacitor, maintaining stability of walls and enhancing stability of components. The chip part includes: a substrate, having a first main surface and a second main surface opposite to the first main surface; a capacitive film, disposed on the first main surface; a first external electrode, disposed on the capacitive film; a second external electrode, disposed on the second main surface; and a conductive layer, disposed between the capacitive film and the substrate. A vertical capacitor having a laminated structure of an upper electrode (first external electrode)-capacitive film-lower electrode (substrate) is formed in a lengthwise direction along the thickness direction of the substrate.

### TECHNICAL FIELD

The present disclosure relates to chip parts.

### BACKGROUND

Patent document 1 discloses a chip capacitor including a substrate, a first conductive film and a first pad film formed on the substrate, a dielectric layer formed on the first conductive film and the first pad film, and a second conductive film formed on the dielectric film and including a second connection region and a second capacitor forming region. The first conductive film includes a first connection region and a first capacitor forming region. A first external electrode is bonded to the first connection region of the first conductive film, and a second external electrode is bonded to the second connection region of the second conductive film.

### PRIOR ART DOCUMENT

### Patent Publication

[Patent document 1] Japan Patent Publication No. 2017-195322

### SUMMARY OF THE PRESENT DISCLOSURE

### Problems to be Solved by the Disclosure

A chip part is provided according to an embodiment of the present disclosure. The chip part is capable of efficiently utilizing the lateral space of a semiconductor substrate and ensuring a larger capacitance for a capacitor.

A chip par is further provided according to an embodiment of the present disclosure. The chip part is capable of ensuring a larger capacitance for a capacitor, maintaining stability of walls and enhancing stability of components.

### Technical Means for Solving the Problem

A chip part according to an embodiment of the present disclosure includes: a semiconductor substrate, having a first main surface and a second main surface opposite to the first main surface; a capacitive film, disposed on the first main surface; a first electrode, disposed on the capacitive film; a second electrode, disposed on the second main surface; and a conductive layer, disposed between the capacitive film and the semiconductor substrate.

### Effects of the Disclosure

In the chip part according to an embodiment of the present disclosure, the first electrode is opposite to the semiconductor substrate (the second electrode) interposed by the capacitive film in between. Thus, a vertical capacitor having a laminated structure of an upper electrode -capacitive film-lower electrode is formed in a lengthwise direction along the thickness direction of the semiconductor substrate. With the vertical capacitor, the first electrode can be disposed on the first main surface and the second electrode can be disposed on the second main surface. Hence, it is not necessary to arrange these external electrodes along the widthwise direction of the first main surface of the semiconductor substrate. Therefore, the lateral space of the semiconductor substrate can be efficiently utilized, thereby providing the small-size chip part.

Moreover, the conductive layer is disposed between the capacitive film and the semiconductor substrate. Thus, the resistance value in the first main surface of the semiconductor substrate can be replaced by the resistance value of the conductive layer from the resistance value of the semiconductor, thereby reducing the resistance value on the side of the second electrode. As a result, loss of the capacitor can be reduced.

### BRIEF DESCRIPTION OF THE DRAWINGS

FIG. 1 is a perspective schematic diagram of a chip part according to an embodiment of the present disclosure.

FIG. 2 is a schematic top view of the chip part.

FIG. 3 is a schematic bottom view of the chip part.

FIG. 4 is a schematic section diagram of the chip part.

FIG. 5A is a schematic section diagram of a part of a manufacturing step of the chip part.

FIG. 5B is a diagram of a next step of FIG. 5A.

FIG. 5C is a diagram of a next step of FIG. 5B.

FIG. 5D is a diagram of a next step of FIG. 5C.

FIG. 5E is a diagram of a next step of FIG. 5D.

FIG. 5F is a diagram of a next step of FIG. 5E.

FIG. 6 is a schematic top view of the chip part.

FIG. 7 is a schematic bottom view of the chip part.

FIG. 8 is a schematic section diagram of the chip part.

FIG. 9A is a schematic section diagram of a part of a manufacturing step of the chip part.

FIG. 9B is a diagram of a next step of FIG. 9A.

FIG. 9C is a diagram of a next step of FIG. 9B.

FIG. 9D is a diagram of a next step of FIG. 9C.

FIG. 10 is a schematic top view of the chip part.

FIG. 11 is a schematic bottom view of the chip part.

FIG. 12 is a schematic section diagram of the chip part.

FIG. 13 is a schematic top view of the chip part

FIG. 14 is a schematic bottom view of the chip part.

FIG. 15 is a schematic section diagram of the chip part.

FIG. 16 is a schematic top view of the chip part.

FIG. 17 is a schematic bottom view of the chip part.

FIG. 18 is a schematic section diagram of the chip part.

FIG. 19A is a schematic section diagram of a part of a manuthcturing step of the chip part.

FIG. 19B is a diagram of a next step of FIG. 19A.

FIG. 19C is a diagram of a next step of FIG. 19B.

FIG. 19D is a diagram of a next step of FIG. 19C.

FIG. 19E is a diagram of a next step of FIG. 19D.

FIG. 19F is a diagram of a next step of FIG. 19E.

FIG. 19G is a diagram of a next step of FIG. 19F.

FIG. 19H is a diagram of a next step of FIG. 19G.

FIG. 19I is a diagram of a next step of FIG. 19H.

FIG. 20 is a schematic top view of the chip part.

FIG. 21 is a schematic bottom view of the chip part.

FIG. 22 is a schematic section diagram of the chip part

FIG. 23 is a schematic section diagram of the chip part.

FIG. 24 is a schematic section diagram of the chip part.

### DETAILED DESCRIPTION OF THE EMBODIMENTS

Details of the embodiments of the present disclosure are given with the accompanying drawings below.

### Appearance of Chip Part 1

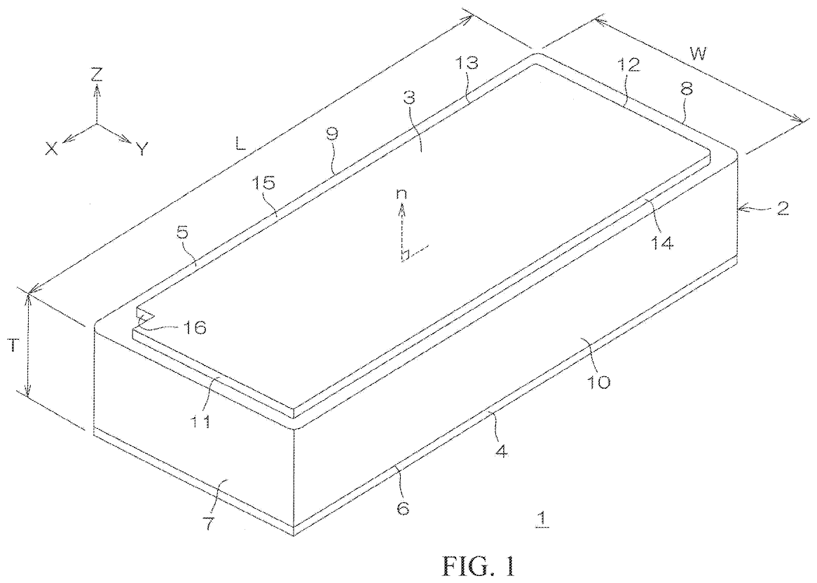

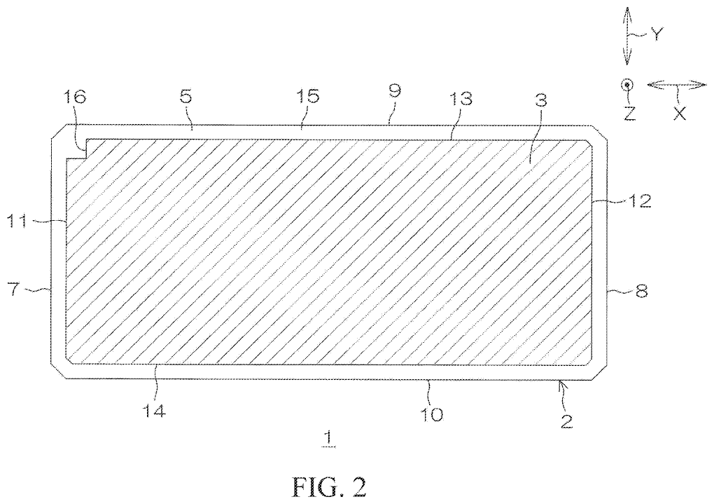

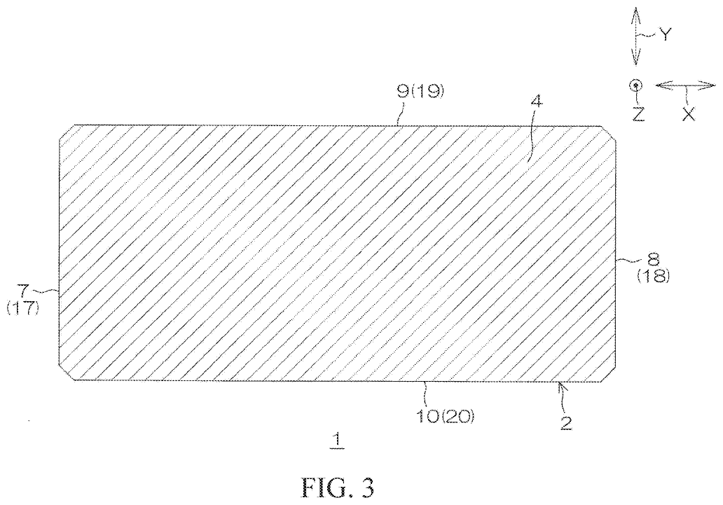

FIG. 1 shows a perspective schematic diagram of a chip part 1 according to an embodiment of the present disclosure. FIG. 2 shows a schematic top view of the chip part 1. FIG. 3 shows a schematic bottom view of the chip part 1. In FIG. 1 to FIG. 3, the lengthwise direction of the chip part 1 having a cuboid shape is defined as a first direction X, the widthwise direction of the chip part 1 is defined as a second direction Y, and a thickness direction of the chip part 1 is defined as a third direction Z. Moreover, in FIG. 2 and FIG. 3. for clarity, a first external electrode 3 and a second external electrode 4 are shaded by lines.

The chip part 1 is formed in a cuboid shape, and has a length L in the first direction X, a width W in the second direction Y and a thickness T in the third direction Z. The length L may be, for example, 0.4 mm or more and 2 mm or less. The width W may be, for example, 0.2 mm or more and 2 mm or less. The thickness T may be, for example, 0.1 mm or more and 0.5 mm or less.

The chip part 1 may also be a small-size electronic component using a chip designation (length L (mm)×width W (mm), for example, referred to as a 1608 (1.6 mm ×0.8 mm) chip, a 1005 (1.0 mm×0.5 mm) chip, 0603 (0.6 mm×0.3 mm) chip, 0402 (0.4 mm×0.2 mm) chip, or 03015 (0.3 mm×0.15 mm) chip.

The chip part 1 includes a substrate 2, a first external electrode 3 and a second external electrode 4.

The substrate 2 forms a base substrate of the chip part 1. The chip part 1 is formed by supporting a plurality of insulating films and metal films laminated on each other on the substrate 2. The substrate 2 exhibits a cuboid shape having substantially the same dimensions as the chip part 1. In this embodiment, the substrate 2 may also be a semiconductor substrate such as a silicon substrate. The thickness of the substrate 2 may be, for example, 80 μm or more and 150 μm or less.

The substrate 2 has a first main surface 5, a second main surface 6 and four side surfaces 7 to 10. The first main surface 5 is the so-called front side of the chip part 1, and the second main surface 6 is the obverse side of the chip part 1. The four side surfaces 7 to 10 surround the first main surface 5 when observed in a plan view and along a normal direction n of the first main surface 5 (to be referred to as the plan view). The four side surfaces 7 to 10 may also include a pair of a first side surface 7 and a second side surface 8 opposite to each other in the first direction X, and a pair of a third side surface 9 and a fourth side surface 10 opposite to each other in the second direction Y. In other words, the side surfaces extending in parallel to each other in the second direction Y may be the first side surface 7 and the second side surface 8 on the lateral side of the substrate 2, and the side surfaces extending in parallel to each other in the first direction X may be the third side surface 9 and the fourth side surface 10 on the longitudinal side of the substrate 2. The first side surface 7, the second side surface 8, the third side surface 9 and the fourth side surface 10 may also be referred to as a first end surface, a second end surface, a third end surface and a fourth end surface, respectively.

The first external electrode 3 is formed to cover substantially an entirety of the first main surface 5. The first external electrode 3 has side surfaces 11 to 14 spaced inward with respect to the side surfaces 7 to 10. The four side surfaces 11 to 14 may be a pair of a. first side surface 11 and a second side surface 12 opposite to each other in the first direction X and parallel to the pair of the first side surface 7 and the second side surface 8, and a pair of a third side surface 13 and a fourth side surface 14 opposite to each other in the second direction Y and parallel to the pair of the third side surface 9 and the fourth side surface 10. A region between the side surfaces 11 to 14 of the first external electrode 3 and the side surfaces 7 to 10 of the substrate 2 may be an insulative space 15 that exposes an insulative portion on the first main surface 5 of the substrate 2. The side surfaces 11 to 14 of the first external electrode 3 may also be alternatively referred to as an end edges or end surfaces of the first external electrode 3.

A notch 16 is formed on a peripheral edge of the first external electrode 3. The notch 16 may also function as a label for determining the direction of the chip part 1 when the chip part 1 is mounted on the substrate, for example. For example, by visually identifying the position of the notch 16, the orientations of the lengthwise direction (the first direction X) and the widthwise direction (the second direction Y) of the chip part 1 can be identified from outside the chip part 1. In this embodiment, the notch 16 is formed by selectively removing a corner of the substrate 2 opposite to a corner of the first external electrode 3. Alternatively, a total of two notches 16 may be formed individually on a pair of corners corresponding to the side of the first side surface 7 of the substrate 2 in the first direction X. However, from the perspective of an indicator for the direction of the chip part 1, the notch is preferably formed corresponding to one corner, as shown in FIG. 1 and FIG. 2. Thus, the chip part 1 having a rectangular shape in the plan view can be asymmetric in either of the aspects of line symmetry (for example, line symmetry about a line along the first direction X and the second direction Y as the axis of symmetry) and dot symmetry.

The second external electrode 4 is disposed on the second main surface 6. The second external electrode 4 is formed to cover an entirety of the second main surface 6. The second external electrode 4 has a shape consistent with that of the second main surface 6, and has side surfaces 17 to 20 consistent with the side surfaces 7 to 10 of the substrate 2. The four side surfaces 17 to 20 may be a pair of a first side surface 17 and a second side surface 18 opposite to each other in the first direction X and consistent with the pair of the first side surface 7 and the second side surface 8, and a pair of a third side surface 19 and a fourth side surface 20 opposite to each other in the second direction Y and consistent with the pair of the third side surface 9 and the fourth side surface 10. The second external electrode 4 is in direct contact with the substrate 2, and is electrically and mechanically connected at the substrate 2. The first external electrode 3 and the second external electrode 4 are selectively disposed on the first main surface 5 and the second main surface 6 of the substrate 2, respectively. Thus, in this embodiment, the side surfaces 7 to 10 of the substrate 2 may be exposed surfaces not covered by electrode films of the first external electrodes 3 and the second external electrode 4 and hence exposed from the semiconductor surface of the substrate 2.

### Section Structure of Chip Part 1

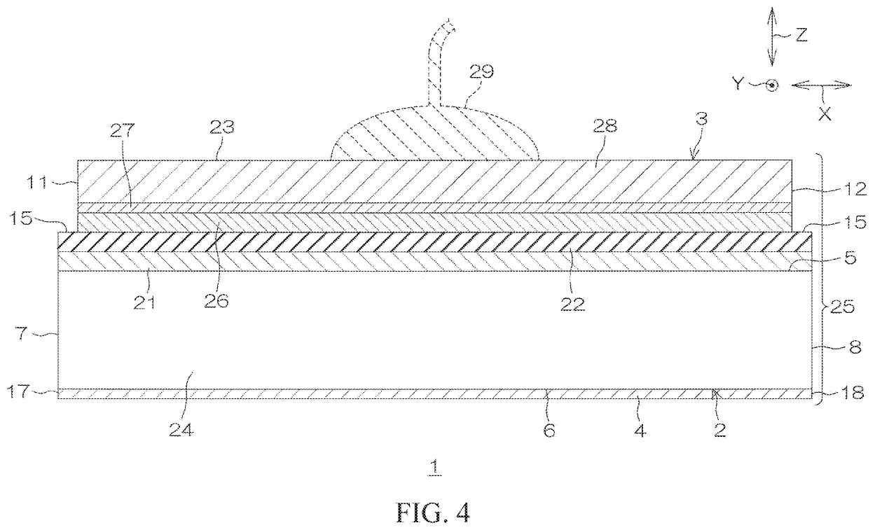

FIG. 4 shows a schematic section diagram of the chip part 1. FIG. 4 shows a schematic diagram of the laminated structure on the first main surface 5 of the chip part 1, but is not a cross section along any specific section line in FIG. 2.

Referring to FIG. 4, a conductive layer 21 and a capacitive film 22 are laminated on the first main surface 5 of the substrate 2.

The conductive layer 21 is formed to cover an entirety of the flat first main surface 5 of the substrate 2. Thus, the conductive layer 21 has an end surface consistent with the side surfaces 7 to 10 of the substrate 2. The term “the flat first main surface” 5 may be defined as, there are not recessed such as trenches intentionally formed by means of etching on the first main surface 5 such that the surface of a forming surface of a component formed by a semiconductor wafer can be kept as a flat surface. The thickness of the conductive layer 21 may be, for example, 0.1 μm or more and 2.0 μm or less.

Moreover, the conductive layer 21 may be a metal layer or a polycrystalline silicon (polysilicon) layer, or a laminated layer of the above. In this embodiment, the conductive layer 21 is formed by one single metal layer. For example, the conductive layer 21 implemented by a metal layer may be, for example, an Al layer or an Au layer. The conductive layer 21 implemented by a polysilicon layer may be, for example, a polysilicon layer containing impurities.

The capacitive film 22 is formed to cover an entirety of the conductive layer 21. Thus, the capacitive film 22 has an end surface consistent with the side surfaces 7 to 10 of the substrate 2. The thickness of the capacitive film 22 may be, for example, 2 μm or more and 8 μm or less.

The capacitive film 22 may be a SiO₂ film, a silicon nitride (SiN) film, or a laminated film of the above. For example, the capacitive film 22 may also be a SiO₂/SiN laminated film, or a SiO₂/SiN/SiO₂ laminated film. Moreover, the capacitive film 22 may also be an oxide-nitride (ON) film, or an oxide-nitride-oxide (ONO) film, or may be a laminated film of the above. Further, the capacitive film 22 may also be an insulating film including a high dielectric material (high-k material). A high dielectric material, in addition to aluminum oxide (Al₂O₃), tantalum pentoxide (Ta₂O₅), titanium pentoxide (Ti₃O₅) and hafnium oxide (HfO₂), the high dielectric material may further include, for example, perovskite compounds such as strontium titanate (SrTiO₃) and barium strontium titanate (BaₓSr₁₋ₓ) TiO₃. In this embodiment, the capacitive film 22 is formed by a SiO₂ film.

The first external electrode 3 is disposed on the capacitive film 22. The first external electrode 3 is opposite to the substrate 2 interposed by the capacitive film 22 in between. in the chip part 1, a capacitor 25 is formed by the capacitive film 22, and the first external electrode 3 (an upper electrode 23) and the substrate 2 (a lower electrode 24) interposed by the capacitive film 22. Moreover, in FIG. 4, the substrate 2 is represented as the lower electrode 24; however, a laminated structure including the second external electrode 4, the substrate 2 and the conductive layer 21 may be defined as the lower electrode. That is to say, the lower electrode may be formed by a conductive laminated structure including a pair of metal layers (that is, the conductive layer 21 and the second external electrode 4) that sandwich the semiconductor layer of the substrate 2 from top and bottom.

The first external electrode 3 may also include a laminated film including a plurality of conductive layers. For example, the first external electrode 3 may also include a first layer 26, a second layer 27 and a third layer 28 sequentially laminated from the substrate 2, The first layer 26 may also be referred to as, for example, a barrier layer including Ti. The second layer 27 may also be referred to as, for example, a spluttering layer including Au. The third layer 28 may also be referred to as, for example, a coating layer including Au. When the second layer 27 and the third layer 28 are formed by the same material, there may be no boundary between the two. The third layer 28 may be thicker than the first layer 26 and the second layer 27. For example, the first layer 26 may be, for example, 1000 Å or more and 3000 Å or less, the second layer 27 may be, for example, 300 Å or more and 1000 Å or less, and the third layer 28 may be 1 μm or more and 3 μm or less.

The second external electrode 4 is connected to the second main surface 6 of the substrate 2. The second external electrode 4 is electrically connected to the lower electrode 24. The second external electrode 4 may also be, for example, a Ni/PdAu laminated film sequentially including an Ni film, a Pd film and an Au film from the substrate 2.

In this embodiment, the first external electrode 3 and the second external electrode 4 form two terminals of the vertical chip part 1. The vertical chip part 1 can be, for example, bonded on the substrate via the second external electrode 4, and bonded to the first external electrode 3 by a bonding member such as a bonding wire 29 for further use.

According to the chip part 1, the upper electrode 23 is opposite to the lower electrode 24 (the substrate (2)) interposed by the capacitive film 22 in between. Thus, the vertical capacitor 25 having a laminated structure including the upper electrode 23-capacitive film 22-lower electrode 24 is formed in the lengthwise direction along the thickness direction of the substrate 2. With the vertical capacitor 25, the first external electrode 3 used for the upper electrode 23 can be disposed on the first main surface 5 and the second external electrode 4 used for the lower electrode 24 can be disposed on the second main surface 6. Hence, it is not necessary to arrange these external electrodes 3 and 4 along the widthwise direction of the first main surface 5 of the semiconductor substrate 2, Therefore, the lateral space of the semiconductor substrate 2 can be efficiently utilized, thereby providing the small-size chip part 1.

While miniaturization can be achieved, since the lower electrode 24 includes the substrate 2 (a semiconductor substrate), there is a concern that loss may be caused by the resistance of the substrate 2, compared to when the lower electrode is formed by one single metal layer. In view of the above, in the chip part 1, the conductive layer 21 is formed between the capacitive film 22 and the substrate 2. Thus, the resistance value in the first main surface 5 of the substrate 2 can be replaced by the resistance value of the conductive layer 21 from the resistance value of the substrate 2 (the resistance value of the semiconductor), thereby reducing the resistance value on the side of the lower electrode 24. As a result, loss of the capacitor 25 can be reduced. Moreover, the thickness of the substrate 2 is 80 μm or more and 150 μm or less. Thus, the substrate 2 can be provided with a low resistance. As a result, loss of the capacitor 25 can be further reduced.

in addition, the substrate 2 of the chip part 1 is not a ceramic substrate but a semiconductor substrate (a silicon substrate in this embodiment). Thus, the chip part can be well used in a relatively high temperature environment of, for example, around 200° C.

### Manufacturing Method of Chip Part 1

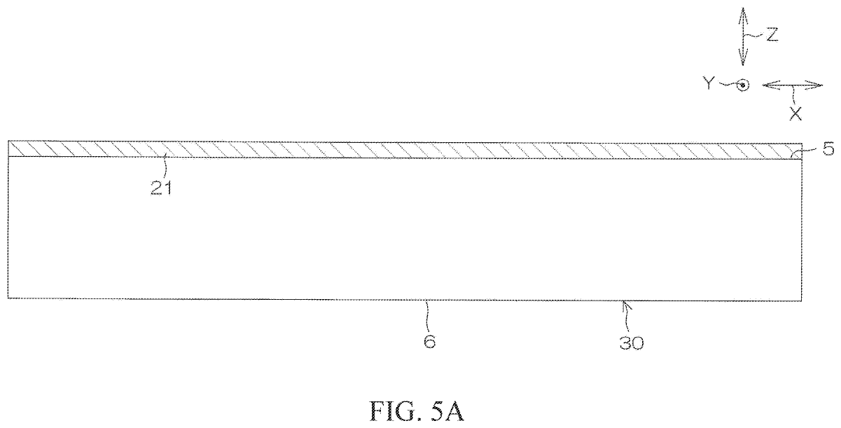

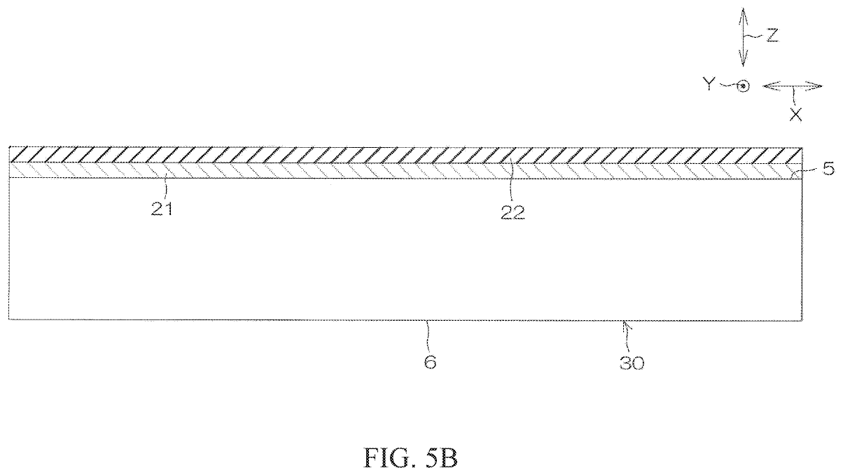

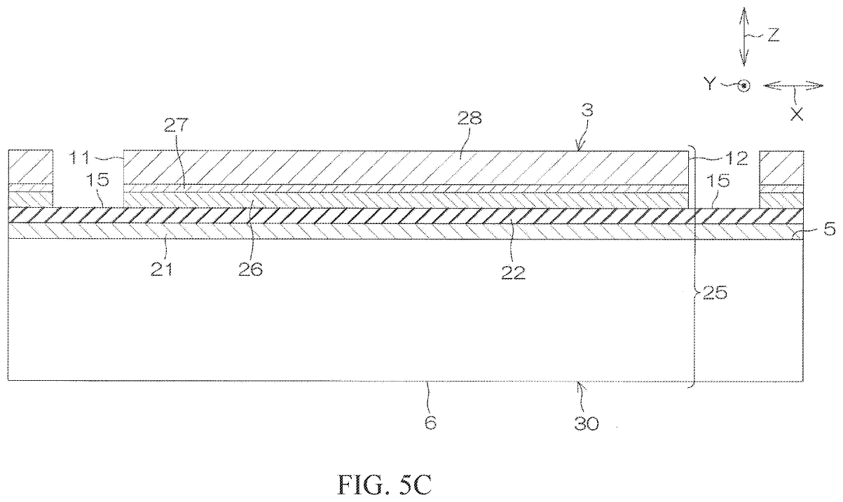

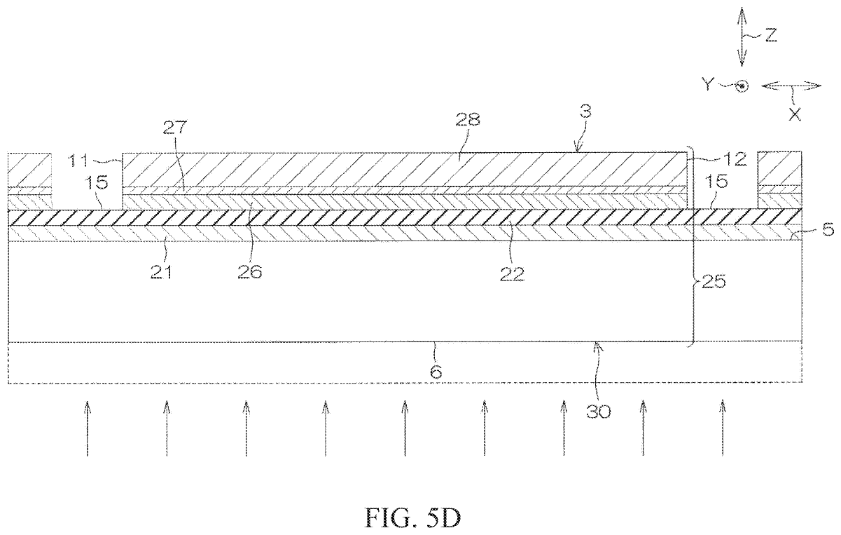

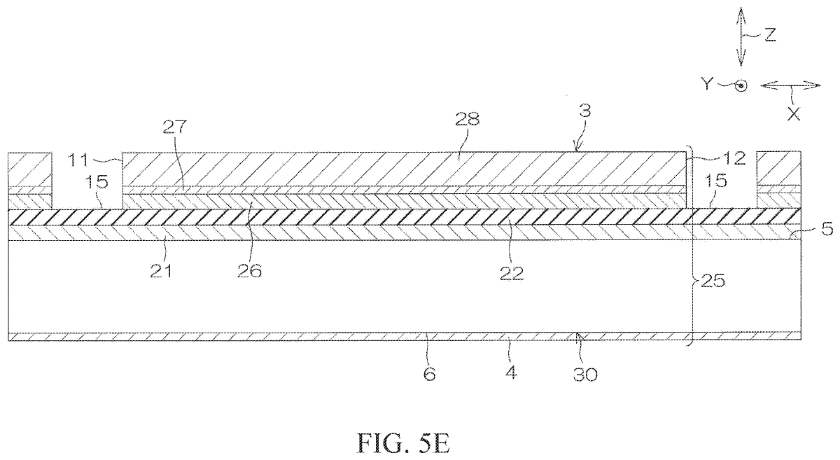

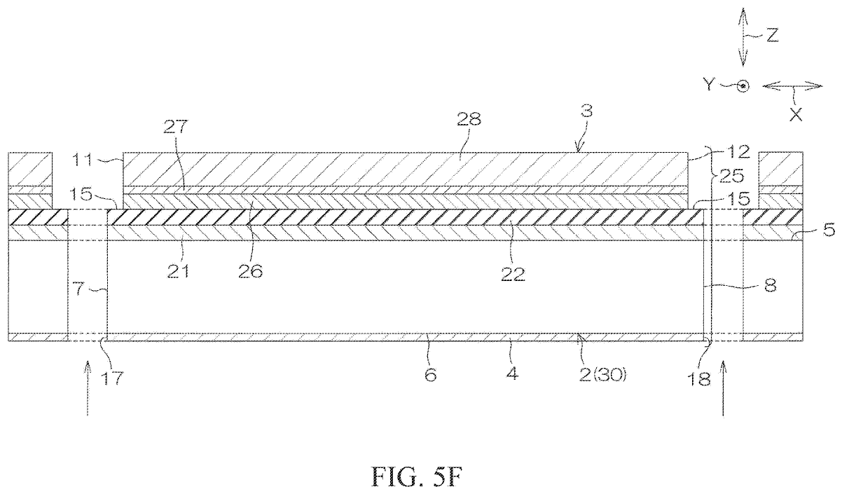

FIG. 5A to FIG. 5F show diagrams of manufacturing steps of the chip part 1 in sequence, and correspond to the cross section in FIG. 4.

To manufacture the chip part 1, first of all, referring to FIG. 5A, a wafer 30 to become a base of the substrate 2 is prepared. Then, by means of sputtering, for example, the conductive layer 21 made of metal is formed on the first main surface 5 of the wafer 30. When the conductive layer 21 includes polysilicon, the conductive layer 21 may also be formed by means of chemical vapor deposition (CND). The conductive layer 21 is formed to cover an entirety of the first main surface 5 of the water 30.

Next, referring to FIG. SB, by means of CM, for example, the capacitive film 22 containing SiO₂ is formed on the conductive layer 21. The capacitive film 22 is formed to cover the entirety of the first main surface S of the wafer 30.

Then, referring to FIG. 5C, the first external electrode 3 is formed. For example, after the first layer 26 and the second layer 27 are sequentially formed by sputtering, the third layer 28 is formed by plating deposition from the second layer 27.

Next, referring to FIG. 5D, the wafer 30 is ground from the second main surface 6. Thus, the wafer 30 is thinned.

Next, referring to FIG. SE, by means of sputtering, for example, the second external electrode 4 is formed on the second main surface 6 of the substrate 2.

Next, referring to FIG, SF. a cutting blade is inserted on the side of the second main surface 6 of the wafer 30 to cut (disconnect) the wafer 30. Thus, the chip parts 1 are obtained after the cutting. The chip parts 1 can be obtained after the steps above.

### Implementation of Chip Part 31

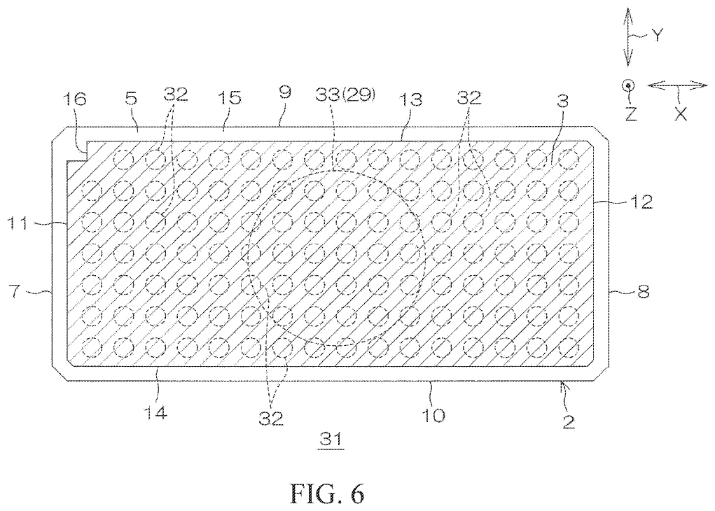

Next, the structure of the chip part 31 is described with reference to FIG. 6 to FIG. 8 below. In FIG. 6 to FIG. 8, structures corresponding to the structures described with reference to FIG. 1 to FIG. 4 are given the same numeral and symbols and the repeated details are omitted below.

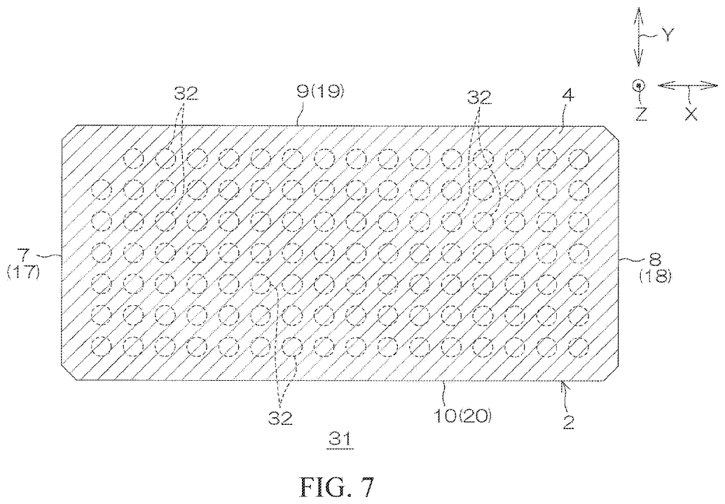

Referring to FIG. 6 and FIG. 7, the chip part 31 further includes penetrating conductive layers 32. In this embodiment, a plurality of penetrating conductive layers 32 are, in a plan view, arranged in a matrix over the entirety of the first main surface 5 of the substrate 2. The plurality of penetrating conductive layers 32 are opposite to both the first external electrode 3 and the second external electrode 4 in the thickness direction (the third direction Z) of the substrate 2. Thus, in the plan view, the plurality of penetrating conductive layers 32 overlap the first external electrode 3 and the second external electrode 4. Moreover, some of the plurality of penetrating conductive layers 32 are formed at positions directly below the bonding area 33 used for the bonding wire 29 on the first external electrode 3, and overlap with the bonding area 33 in the plan view.

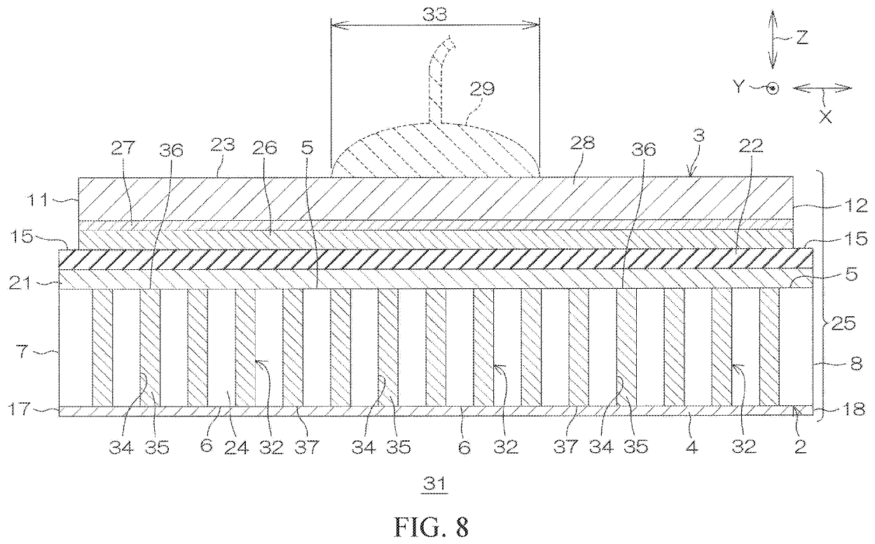

Referring to FIG. 8, the penetrating conductive layers 32 penetrate the substrate 2 in the thickness direction (the third direction Z) and electrically connect the conductive layer 21 to the second external electrode 4. In this embodiment, a plurality of through holes 34 penetrating the substrate 2 in the thickness direction are formed, and conductive vias 35 that back-fill the through holes 34 may be the penetrating conductive layers 32. The conductive vias 35 are lower than the substrate 2, and may be, for example, metal vias (for example, aluminum vias or tungsten vias).

The conductive vias 35 are embedded into the through holes 34, and have a first surface 36 coplanar with the first main surface 5 of the substrate 2 and a second surface 37 coplanar with the second main surface 6 of the substrate 2. Thus, on the first main surface 5 of the substrate 2, in the plan view, a metal surface (a first surface 36) in an island shape (a dot shape) is selectively formed on a semiconductor surface (the first main surface 5) that is substantially a quadrilateral shape, and a flat surface is formed smoothly and continuously by the semiconductor surface and the metal surface without any step difference. Similarly, on the second main surface 6 of the substrate 2, in the plan view, a metal surface (a second surface 37) in an island shape (a dot shape) is selectively formed on a semiconductor surface (the second main surface 6) that is substantially a quadrilateral shape, and a flat surface is formed smoothly and continuously by the semiconductor surface and the metal surface without any step difference.

When observed in cross section, the conductive layer 21 alternately comes into contact with the first main surface 5 of the substrate 2 and the first surface 36 of the conductive vias 35 in the first direction X, and is connected to both the substrate 2 and the conductive vias 35. Moreover, when observed in cross section, the second external electrode 4 alternately comes into contact with the second main surface 6 of the substrate 2 and the second surface 37 of the conductive vias 35 in the first direction X, and is connected to both the substrate 2 and the conductive vias 35.

in addition, the penetrating conductive layer 32 is not necessarily a conductive via 35, and may be, for example, a conductive film presented as a film having a surface and another surface on the opposite side and formed along an inner surface of the through hole 34. That is to say, when the penetrating conductive layers 32 are conductive films, the through holes 34 may not be completely back filled by the penetrating conductive layers 32.

According to the chip part 31 above, the second electrode 4 can be connected to the conductive layer 21 by the penetrating conductive layers 32 having a resistance lower than that of the substrate 2, thereby further reducing loss of the capacitor 25.

### Manufacturing Method of Chip Part 31

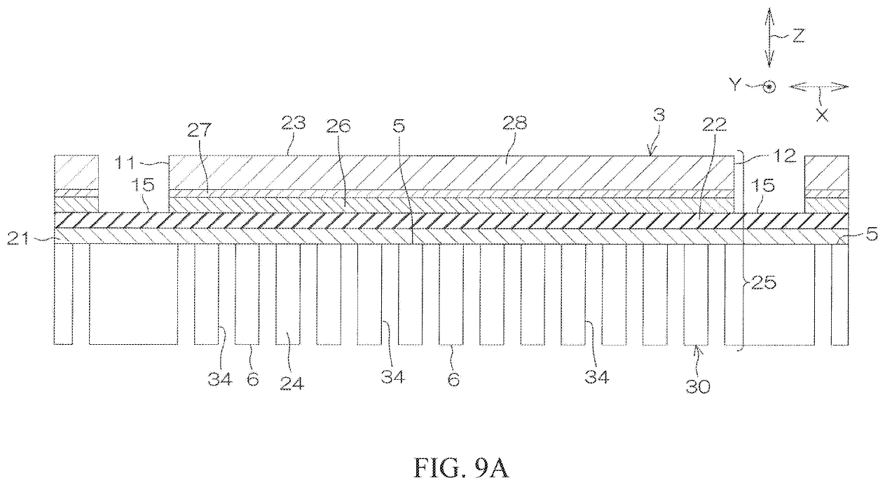

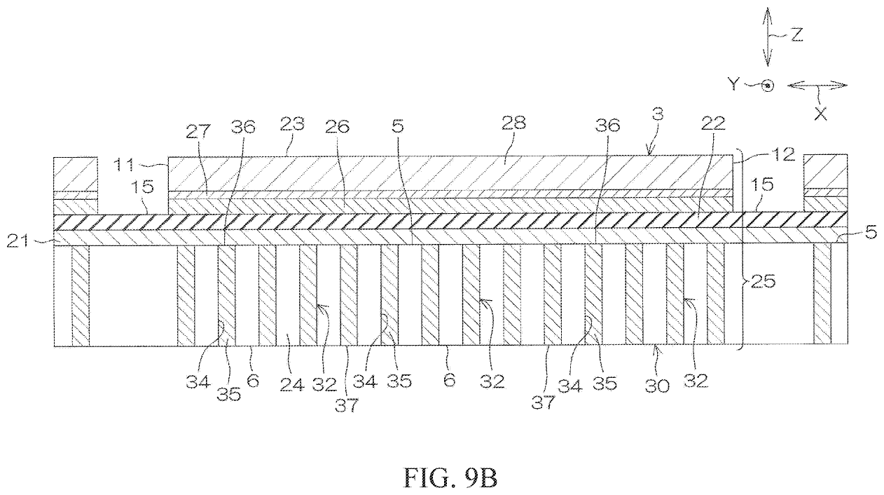

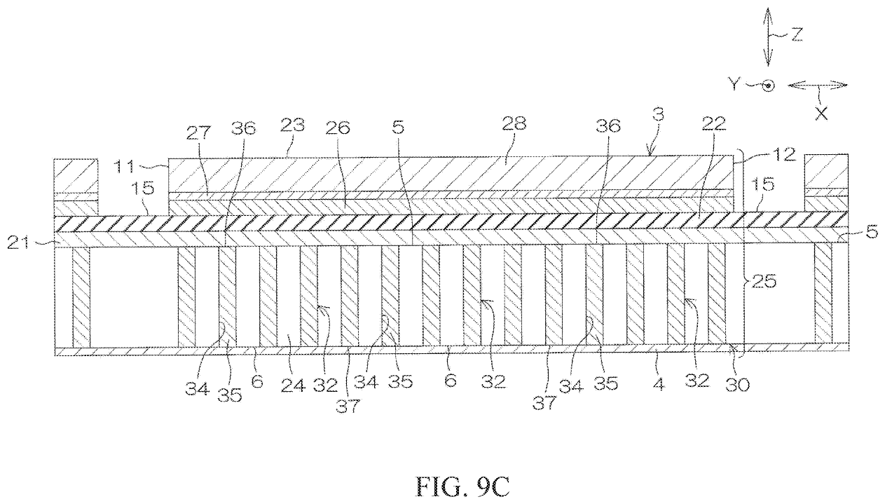

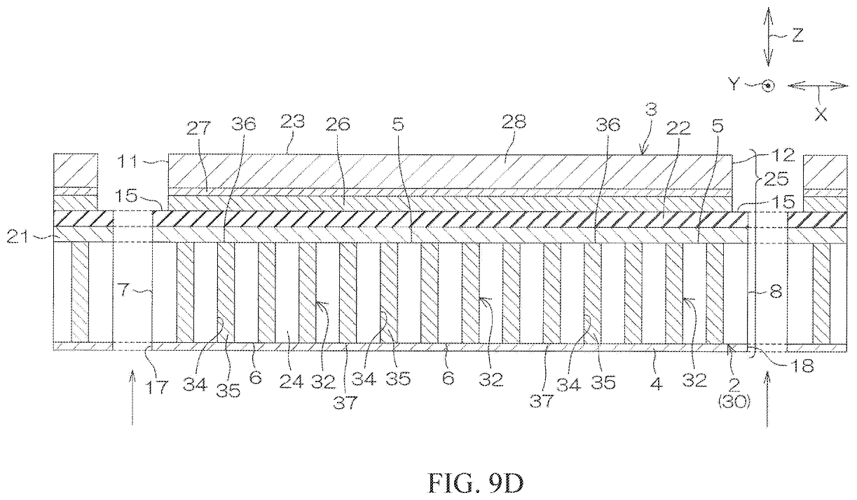

FIG. 9A to FIG. 9D show diagrams of portions of manufacturing steps of the chip part 31 in sequence, and correspond to the cross section in FIG. 8.

To manufacture the chip part 31, first of all, steps shown in FIG. 5A to FIG. 5D are performed. That is to say, up to the step of thinning the wafer 30, the same manufacturing steps as the chip part 1 are performed.

Next, referring to FIG. 9A, the wafer 30 is selectively removed from the second main surface 6. In this embodiment, the wafer 30 is selectively dry etched to form the through holes 34.

Next, referring to :FIG. 913, a material of the conductive vias 35 is deposited on the second main surface 6 of the wafer 30. After the deposition, by means of chemical-mechanical polishing (CMP), for example, the material outside the through holes 34 is removed to form a flat surface with the second surface 37 of the conductive vias 35 and the second main surface 6 of the wafer 30 being continuous.

Next, referring to FIG. 9C, by means of sputtering, for example, the second external electrode 4 is formed on the second main surface 6 of the substrate 2.

Next, referring to FIG. 9D, a cutting blade is inserted on the side of the second main surface 6 of the wafer 30 to cut (disconnect) the wafer 30. Thus, the chip parts 1 are obtained after the cutting. The chip parts 31 can be obtained after the steps above.

### Implementation of Chip Part 41

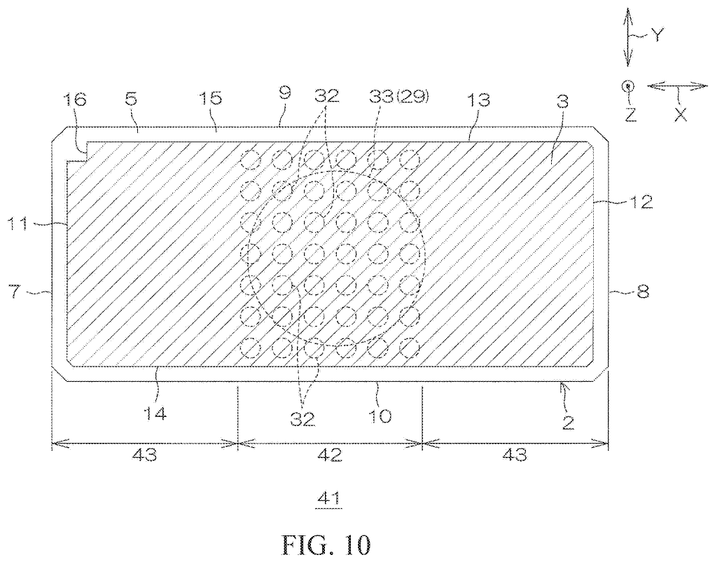

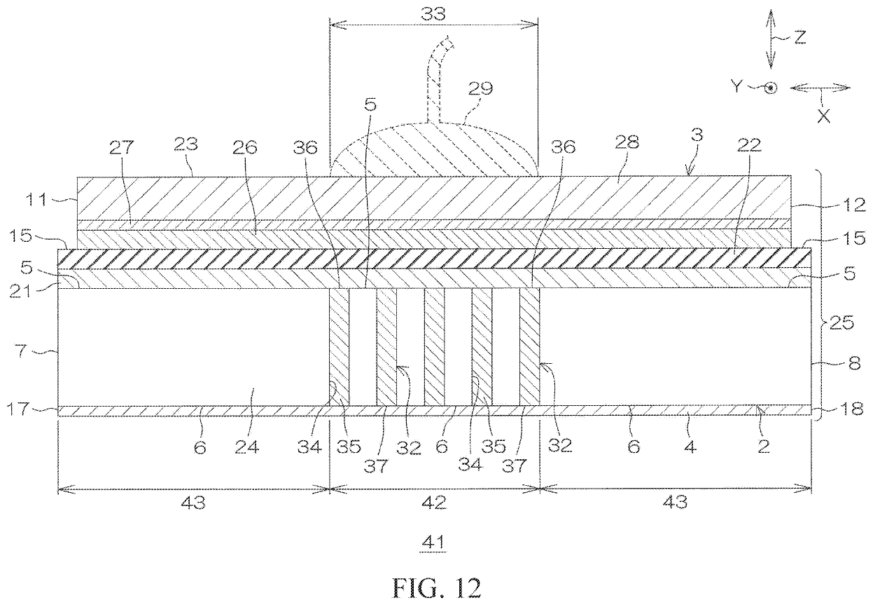

Next, the structure of the chip part 41 is described with reference to FIG. 10 to FIG. 12 below. In FIG. 10 to FIG. 12, structures corresponding to the structures described with reference to FIG. 1 to FIG. 4 and FIG. 6 to FIG. 8 are given the same numeral and symbols and the repeated details are omitted below.

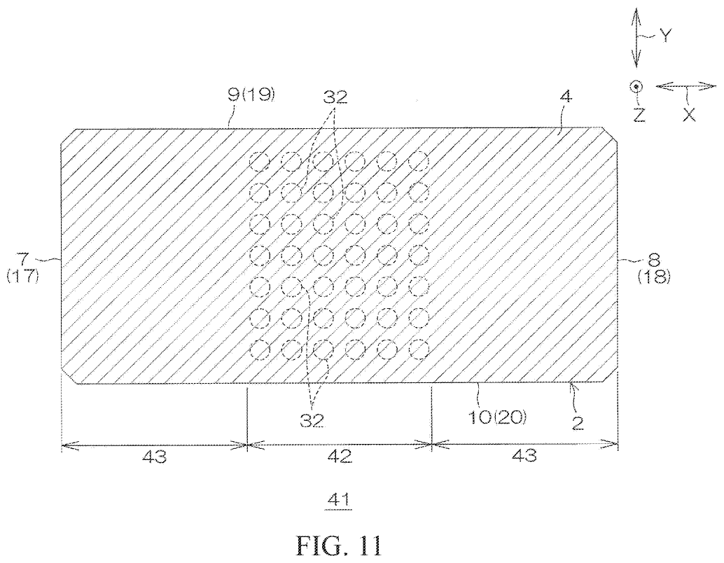

In the chip part 41, the penetrating conductive layers 32 are not formed over the entirety of the first main surface 5 of the substrate 2, but are formed collectively at positions directly below the bonding area 33. On the other hand, most of a region of the substrate 2 that does not overlap the bonding area 33 in the plan view is a semiconductor region kept in a state of the wafer 30. For example, as shown in FIG. 10 and FIG. 11, the substrate 2 may also include: a first region 42, including the penetrating conductive layers 32 formed in a center in the first direction X; and a pair of second regions 43, formed in semiconductor regions on two sides of the first region 42 in the first direction X. The first region 42 is sandwiched between the pair of second regions 43 in the first direction X.

According to the chip part 41, the plurality of penetrating conductive layers 32 are gathered directly under the bonding region 33 with a relatively high current density in direct contact with the bonding wire 29. Thus, electric charge can be more efficiently stored in the capacitor 25.

### Implementation of Chip Part 51

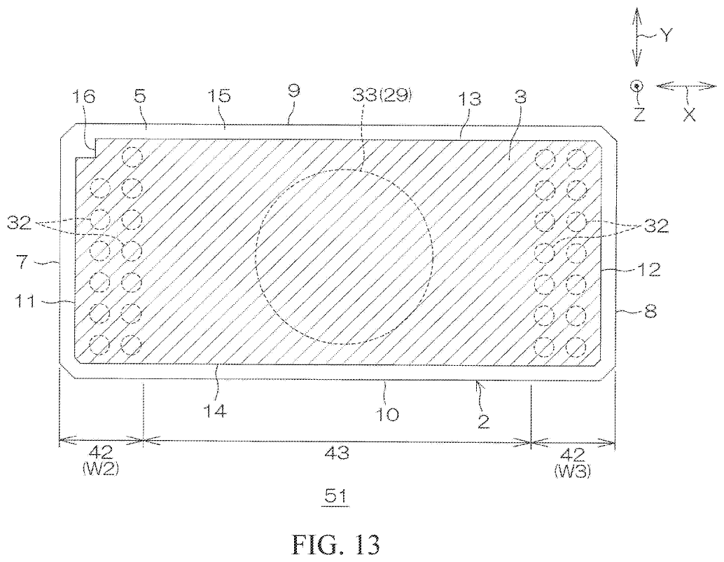

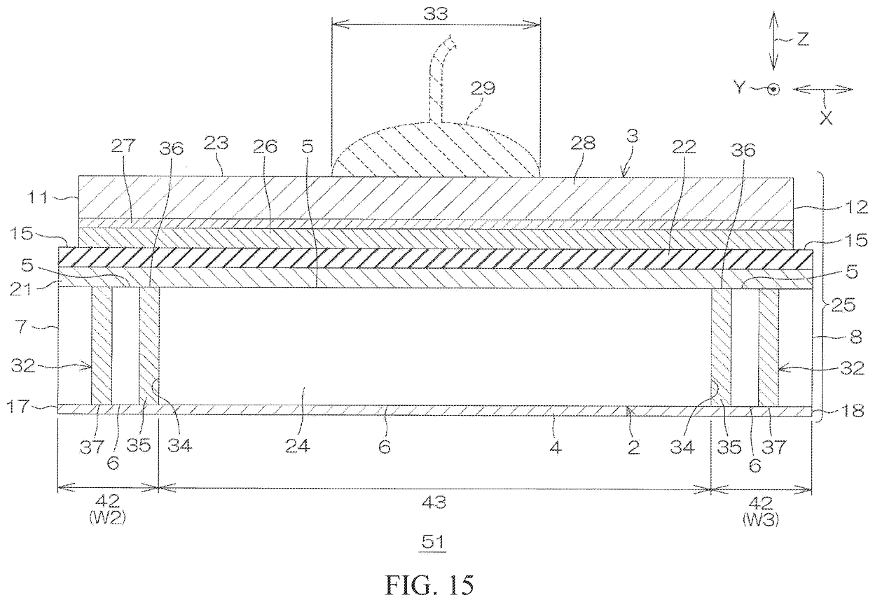

Next, the structure of the chip part 51 is described with reference to FIG. 13 to FIG. 15 below. In FIG. 13 to FIG. 15, structures corresponding to the structures described with reference to FIG. 1 to FIG. 4, FIG. 6 to FIG. 8, and FIG. 10 to FIG. 12 are given the same numeral and symbols and the repeated details are omitted below.

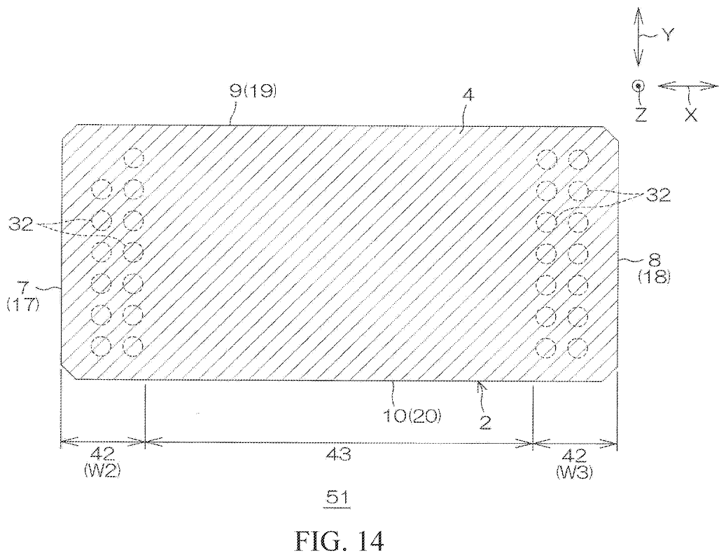

in the chip part 51, the penetrating conductive layers 32 are not formed over the entirety of the first main surface 5 of the substrate 2, but are formed selectively near the side surfaces 7 to 10 of the substrate 2, avoiding the position directly below the bonding area 33. On the other hand, a region of the substrate 2 that overlaps the bonding area 33 in the plan view is a semiconductor region kept in a state of the wafer 30. For example, as shown in FIG. 13 and FIG. 14, the substrate 2 may include the first region 42 near each of the first side surface 7 and the second side surface 8, and a region sandwiched between the pair of first regions 42 in the first direction X is the second region 43. A width W2 and a width W3 occupied by the first regions 42 from the first side surface 7 and the second side surface 8 of the substrate 2 may be, for example, 10% or more and 30% or less of the length L (referring to FIG. 1) of the substrate 2 in the first direction X.

### Implementation of Chip Part 61

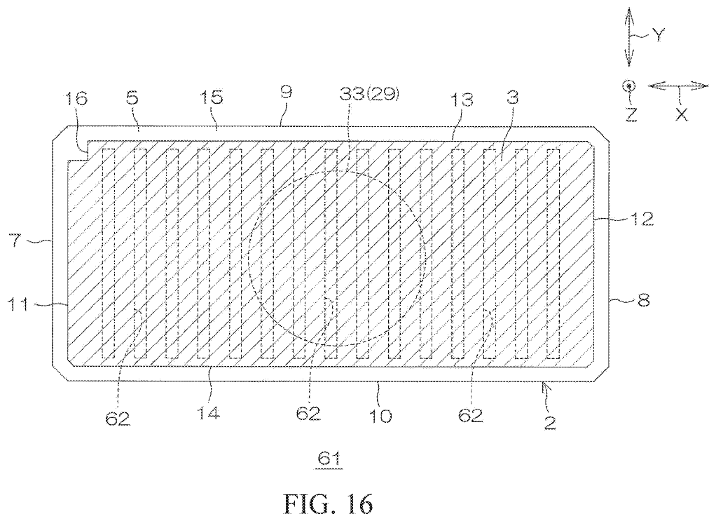

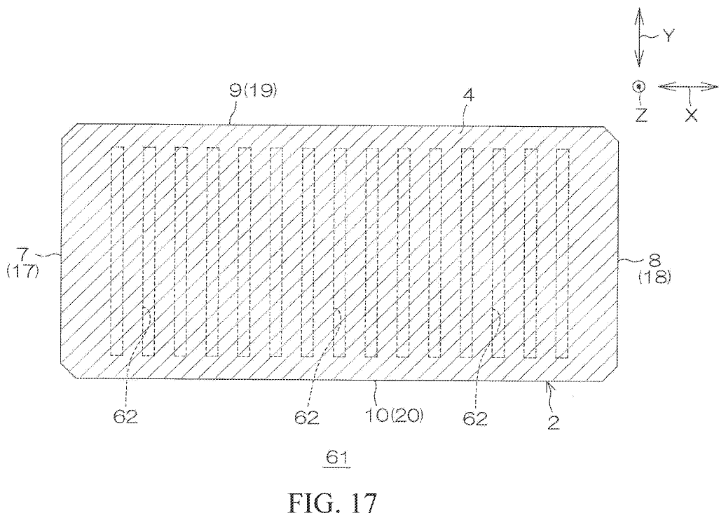

Next, the structure of the chip part 61 is described with reference to FIG. 16 to FIG. 18 below. In FIG. 13 to FIG. 15, structures corresponding to the structures described with reference to FIG. 1 to FIG. 4 are given the same numeral and symbols and the repeated details are omitted below.

In the chip part 61, capacitor trenches 62 are formed on the first main surface 5 of the substrate 2. In this embodiment, a plurality of capacitor trenches 62 are arranged in strip shapes over the entirety of the first main surface 5 of the substrate 2 in the plan view. The plurality of capacitor trenches 62 may be strip shapes extending in parallel to each other in the widthwise direction (the second direction Y) of the substrate 2. Moreover, some of the plurality of capacitor trenches 62 are formed at positions directly below the bonding area 33 used for the bonding wire 29, and overlap with the bonding area 33 in the plan view. Each of the capacitor trenches 62 has an inner surface 65, which includes a bottom surface 63 located in midway of the substrate 2 in the thickness direction and a side surface 64 extending from the bottom surface 63 to the first main surface 5. Moreover, each of the capacitor trenches 62 is formed to extend linearly in the second direction Y. The capacitor trenches 62 are not necessarily linear, and may be, for example, corrugated or zigzagged shapes.

The conductive layer 21 and the capacitor film 22 form a laminated structure 67 having a boundary surface 66 along the inner surface 65 of the capacitor trench 62. The laminated structure 67 has a surface 74 in contact with the first main surface 5, and one other surface 75 on an opposite side, wherein the one surface 74 and the other surface 75 are both along the inner surface 65 of the capacitor trenches 62. Thus, a space 68 surrounded by the laminated structure 67 is formed in each capacitor trench 62. The space 68 is formed by the capacitive film 22.

An embedded electrode 69 is disposed on the capacitive film 22. The embedded electrode 69 is embedded into the space 68, and is formed along the first main surface 5 of the substrate 2. In other words, the embedded electrode 69 is embedded into the capacitor trench 62 through the laminated structure 67. The embedded electrode 69 integrally includes an embedded portion 70 embedded into the capacitor trench 62, and a flat portion 71 connected to an upper end of the embedded portion 70 and formed flatly along the first main surface 5 of the substrate 2. Moreover, the embedded electrode 69 may be made of, for example, a semiconductor material such as polysilicon, or a metal material including Cu or Al. If the embedded electrode 36 is made of a metal material, for example, Cu, Al, AlSi or AlCu may be included. Moreover, the thickness of the embedded electrode 69 (the flat portion 71) may be 4000 Å or more and 10000 Å or less (400 nm or more and 1000 nm or less)

A surface insulating film 72 is disposed on the substrate 2. The surface insulating film 72 covers the embedded electrode 69. The surface insulating film 72 may be, for example, a SiO₂ film or a SiN film. The thickness of the surface insulating layer 72 may be, for example, 10000 Å or more and 15000 Å or less (1 μm or more and 1.5 μm or less). A contact hole 73 that exposes a portion of the embedded electrode 69 is formed on the surface insulating film 72. The first external electrode 3 is electrically connected to the embedded electrode 69 in the contact hole 73 of the surface insulating film 72. Thus, the upper electrode 23 of the capacitor 25 may also be defined by the laminated structure of the embedded electrode 69 and the first external electrode 3.

According to the chip part 61, the capacitor trench 62 is formed, and hence a facing area between the embedded electrode 69 (the upper electrode 23) and the conductive layer 21 (the lower electrode 24) can be increased. Thus, a larger capacitance can be ensured for the capacitor 25.

### Manufacturing Method of Chip Part 61

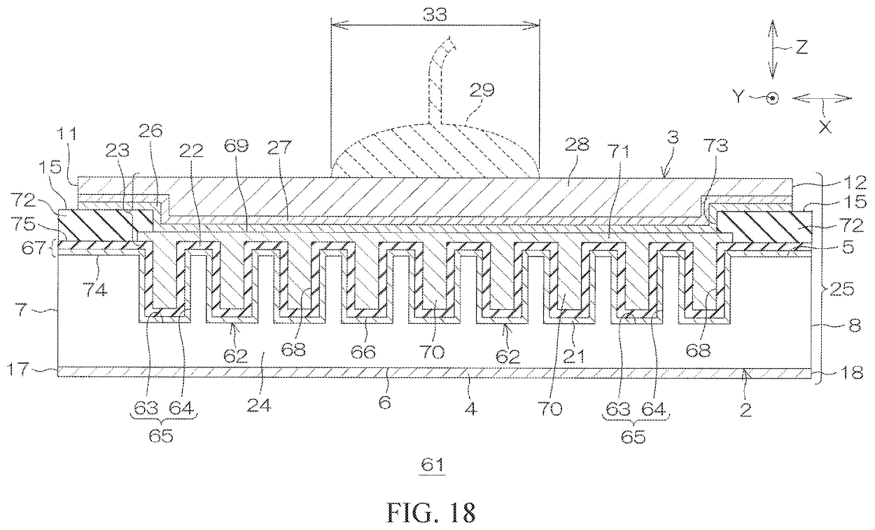

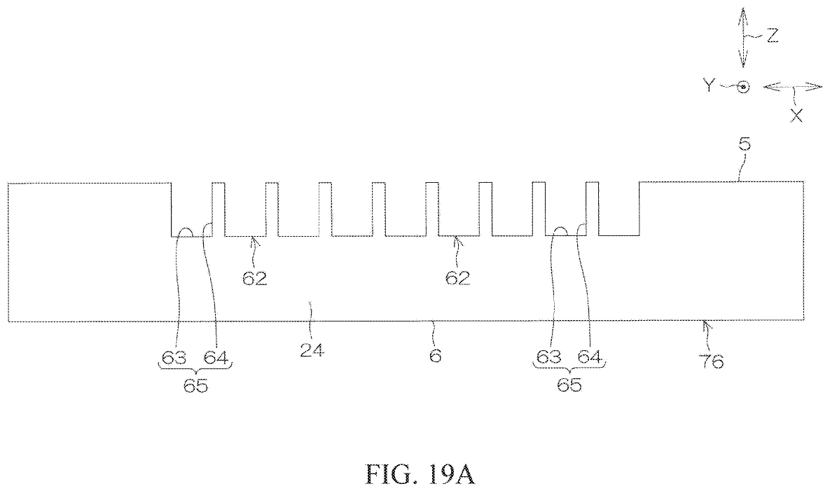

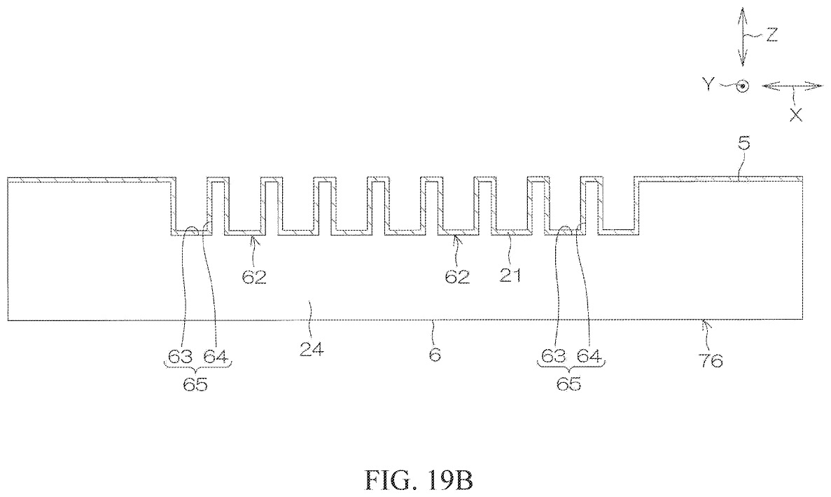

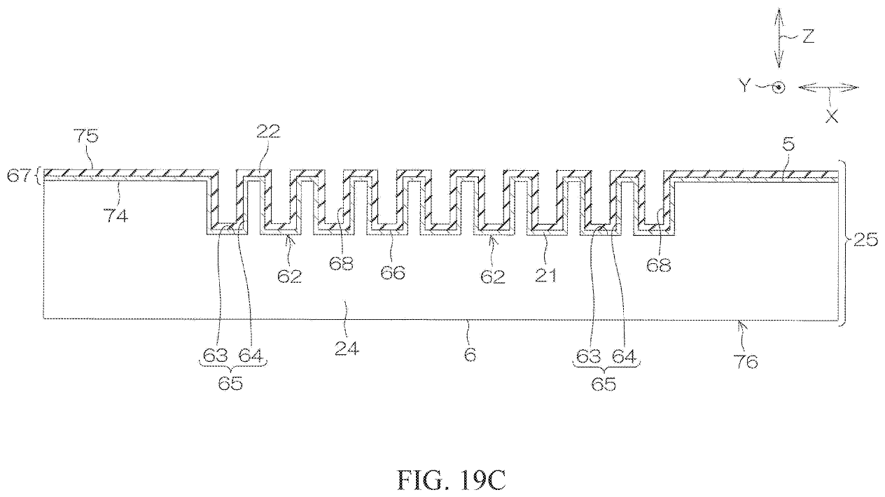

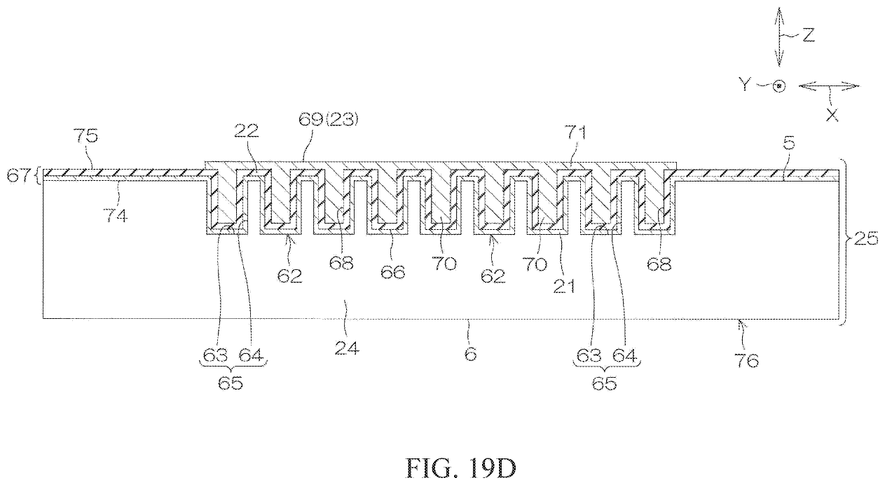

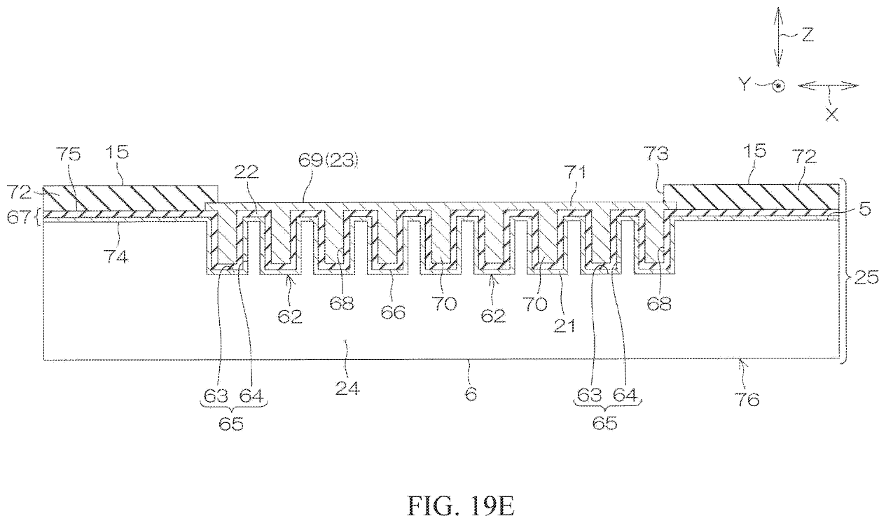

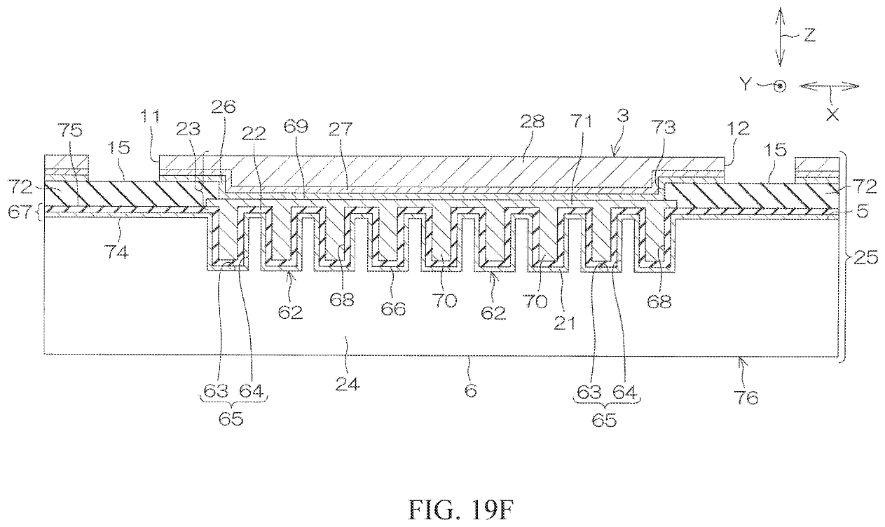

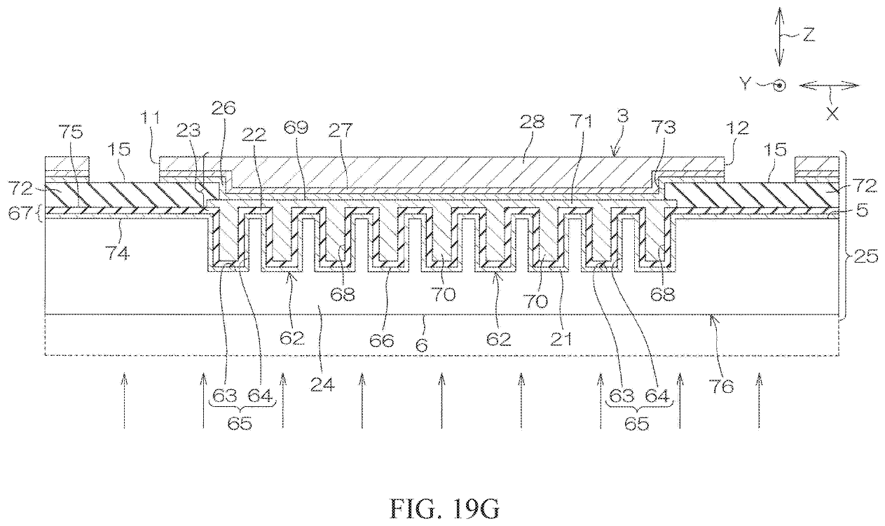

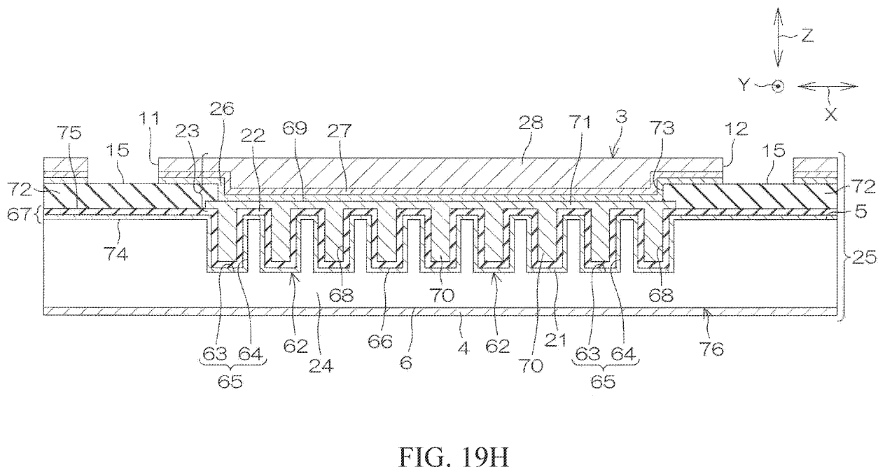

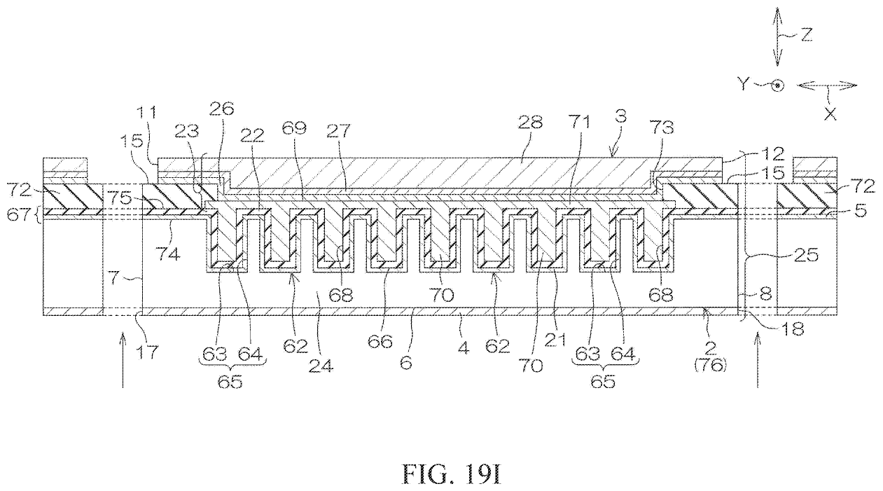

FIG. 19A to FIG. 19I show diagrams of manufacturing steps of the chip part 61 in sequence, and correspond to the cross section in FIG. 18.

To manufacture the chip part 61, first of all, referring to FIG. 19A, a wafer 76 to become a base of the substrate 2 is prepared. Then, for example, a hard mask (not shown) containing SiO₂ is formed by thermally oxidizing the first main surface 5 of the wafer 76. Next, an opening is formed at the hard mask, and etching is selectively performed on wafer 76 by using the hard mask from the side of the first main surface 5. Thus, portions removed from the wafer 76 form the capacitor trenches 62. Dry etching is preferably used as a means of etching.

Next, referring to FIG. 19B, the conductive layer 21 is formed on the first main surface 5 of the wafer 76, and the inner surfaces 65 of the capacitor trenches 62. The conductive layer 21 is formed by means of, for example, sputtering.

Next, referring to FIG. 19C, the capacitive film 22 is formed on the conductive layer 21 on the first main surface 5 of the wafer 76 and the inner surfaces 65 of the capacitor trenches 62. The capacitive film 22 may be formed by means of, for example, CVD. Thus, the laminated structure 67 including the conductive layer 21 and the capacitive film 22 is formed. The space 68 surrounded by the capacitive film 22 is formed in each capacitor trench 62.

Next, referring to FIG. 19D, by means of CVD, for example, a conductive film (not shown) that becomes a base of the embedded electrode 69 is formed on the capacitive film 22. The conductive film is embedded into the capacitor trenches 62 (the spaces 68), and is formed to cover the entire surface of the first main surface 5 of the wafer 76. Then, the conductive film is patterned to form the embedded electrode 69 (the upper electrode 23). Thus, the capacitor 25 including the lower electrode 24 (the wafer 76), the capacitive film 22 and the upper electrode 23 is formed.

Next, referring to FIG. 19E, by means of CVD, for example, the surface insulating film 72 is formed. Then, the surface insulating film 72 is patterned to form the contact hole 73.

Then, referring to FIG. 19F, the first external electrode 3 is formed. For example, after the first layer 26 and the second layer 27 are sequentially formed by sputtering, the third layer 28 is formed by plating deposition from the second layer 27.

Next, referring to FIG. 19G, the wafer 76 is ground from the second main surface 6. Thus, the wafer 76 is thinned.

Next, referring to FIG. 19H, by means of sputtering, for example, the second external electrode 4 is formed on the second main surface 6 of the wafer 76.

Next, referring to FIG. 19I, a cutting blade is inserted on the side of the second main surface 6 of the wafer 76 to cut (disconnect) the wafer 76. Thus, the chip parts 61 are obtained after the cutting.

### Implementation of Chip Part 81

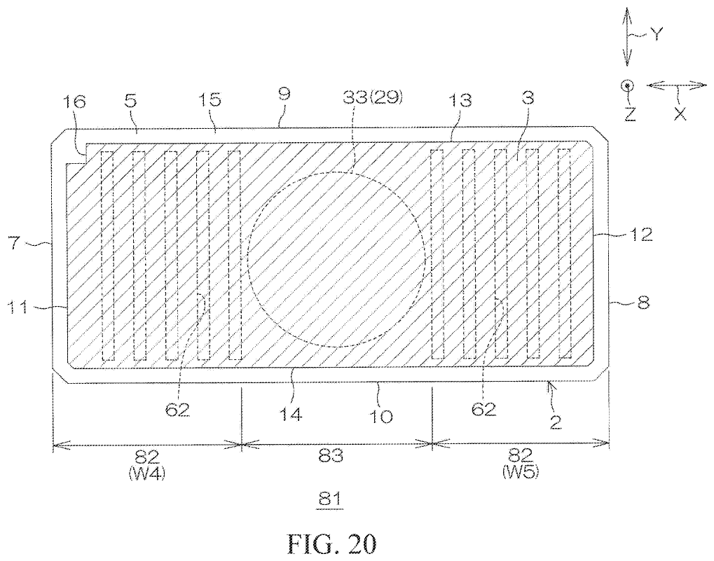

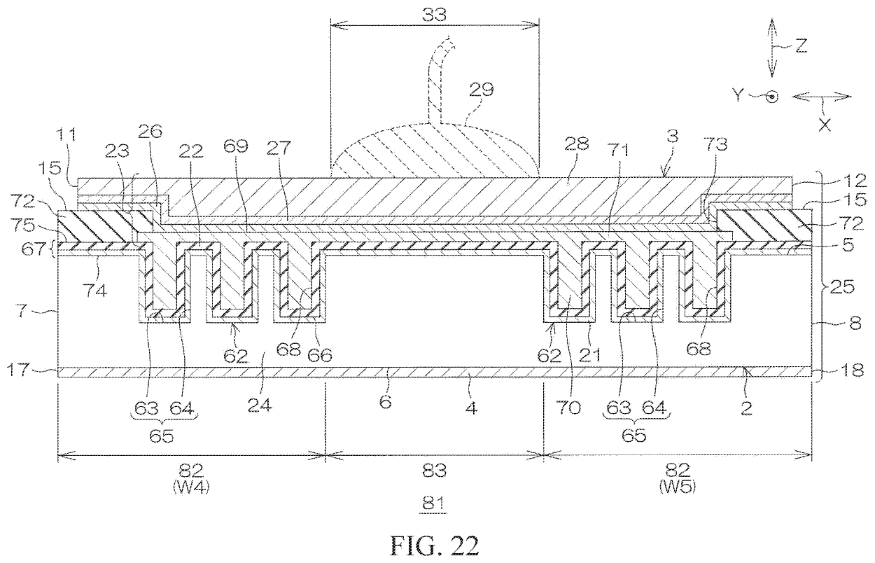

Next, the structure of the chip part 81 is described with reference to FIG. 20 to FIG. 22 below. In FIG. 20 to FIG. 22, structures corresponding to the structures described with reference to FIG. 1 to FIG. 4 and FIG. 16 to FIG. 18 are given the same numeral and symbols and the repeated details are omitted below.

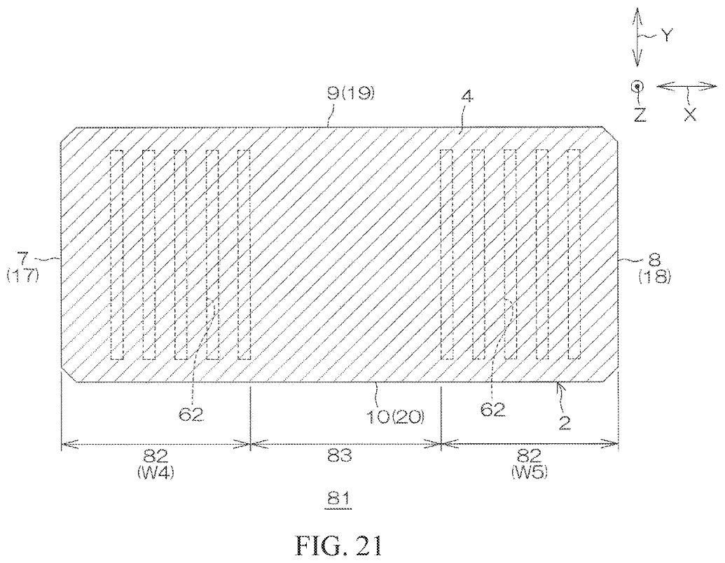

In the chip part 81, the capacitor trenches 62 are not formed over the entirety of the first main surface 5 of the substrate 2, but are formed near the side surfaces 7 to 10 of the substrate 2., avoiding the position directly below the bonding area 33. On the other hand, a region of the substrate 2 that overlaps the bonding area 33 in the plan view is a semiconductor region kept in a state of the wafer 76. For example, as shown in FIG. 20 and FIG. 21, the substrate 2 may include the first region 82 formed near each of the first side surface 7 and the second side surface 8 and having the capacitor trenches 62 formed therein, and a second region 83 including a semiconductor region sandwiched between the pair of first regions 82 in the first direction X. A width W4 and a width W5 occupied by the first regions 82 from the first side surface 7 and the second side surface 8 of the substrate 2 may be, for example, 20% or more and 40% or less of the length L (referring to FIG. 1) of the substrate 2 in the first direction X.

### Implementation of Chip Part 91

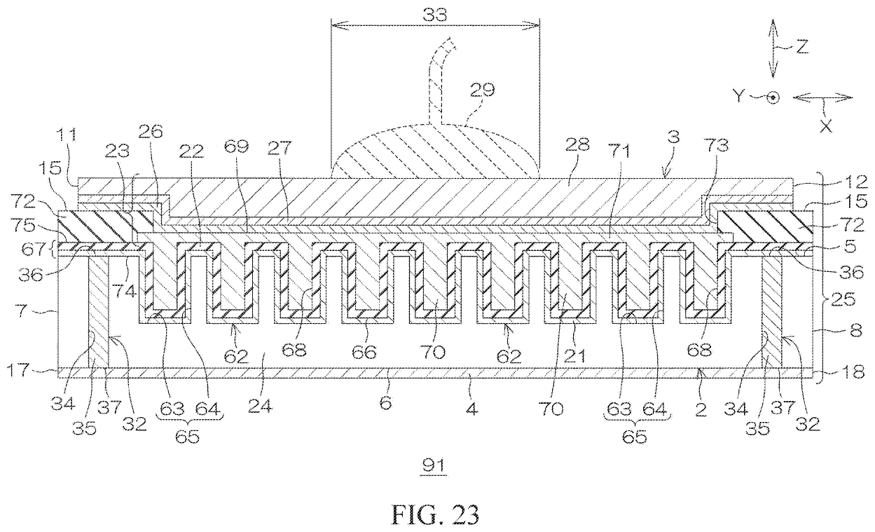

Next, the structure of the chip part 91 is described with reference to FIG. 23 below, In FIG. 23, structures corresponding to the structures described with reference to FIG. 1 to FIG. 4, FIG. 6 to FIG. 8, and FIG. 16 to FIG. 18 are given the same numeral and symbols and the repeated details are omitted below.

The chip part 91 further includes a structure in which the chip part 61 shown in FIG. 18 further includes the penetrating conductive layers 32. The penetrating conductive layers 32 of the chip part 91 are formed to avoid a region where the plurality of capacitor trenches 62 are formed. In FIG. 23, the penetrating conductive layers 32 are formed on a peripheral edge of the substrate 2 outside the plurality of capacitor trenches 62. Thus, the penetrating conductive layers 32 are connected to the conductive layer 21 in the first main surface 5 of the substrate 2.

According to the chip part 91, in addition to ensuring a larger capacitance for the capacitor 25, the second electrode 4 can be connected to the conductive layer 21 by the penetrating conductive layers 32 having a resistance lower than that of the substrate 2, thereby further reducing loss of the capacitor 25.

### Implementation of Chip Part 101

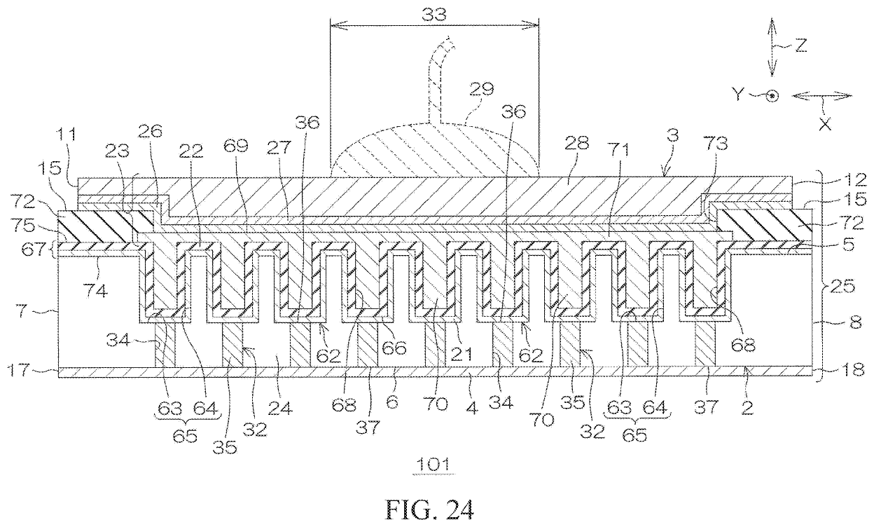

Next, the structure of the chip part 101 is described with reference to FIG. 24 below. In FIG. 24, structures corresponding to the structures described with reference to FIG. 1 to FIG. 4, FIG. 6 to FIG. 8, and FIG. 16 to FIG. 18 are given the same numeral and symbols and the repeated details are omitted below.

The chip part 101 further includes a structure in which the chip part 61 shown in FIG. 18 further includes the penetrating conductive layers 32. The penetrating conductive layers 32 of the chip part 101 are formed at positions directly below a region where the plurality of capacitor trenches 62 are formed. In FIG. 24, the penetrating conductive layers 32 are formed at positions directly below bottoms of the capacitor trenches 62. Thus, the penetrating conductive layers 32 are connected to the conductive layer 21 in bottom surfaces 63 of the capacitor trenches 62.

According to the chip part 101, in addition to ensuring a larger capacitance for the capacitor 25, the second electrode 4 can be connected to the conductive layer 21 by the penetrating conductive layers 32 having a resistance lower than that of the substrate 2, thereby further reducing loss of the capacitor 25.

The embodiments of the present disclosure are described above; however, the present disclosure may also be implemented in other configurations.

The embodiments of the present disclosure described above are examples in all aspects and are not to be interpreted in a restrictive manner, but are intended to encompass modifications in all aspects.

The features given in the notes below can be extracted from the detailed description and the drawings of the present application.

### Note 1-1

A chip part (1, 41, 51, 61, 81, 91, 101) includes:

a semiconductor substrate (2), having a first main surface (5) and a second main surface (6) opposite to the first main surface (5);

a capacitive film (22), disposed on the first main surface (5);

a first electrode (3), disposed on the capacitive film (22);

a second electrode (4), disposed on the second main surface (6); and

a conductive layer (21), disposed between the capacitive film (22) and the semiconductor substrate (2).

According to the configuration, the first electrode (3) is opposite to the semiconductor substrate (2) (the second electrode (4)) interposed by the capacitive film (22) in between. Thus, the vertical capacitor (25) having a laminated structure of the upper electrode (23)-capacitive film (22)-lower electrode (24) is formed in the lengthwise direction along the thickness direction of the semiconductor substrate (2). With the vertical capacitor (25), the first electrode (3) can be disposed on the first main surface (5) and the second electrode (4) can be disposed on the second main surface (6). Hence, it is not necessary to arrange these external electrodes (3, 4) along the widthwise direction of the first main surface (5) of the semiconductor substrate (2). Therefore, the lateral space of the semiconductor substrate (2) can be efficiently utilized, thereby providing the small-size chip part (1, 31, 41, 51, 61, 81, 91, 101).

Moreover, the conductive layer (21) is disposed between the capacitive film (22) and the semiconductor substrate (2). Thus, the resistance value in the first main surface (5) of the semiconductor substrate (2) can be replaced by the resistance value of the conductive layer (21) from the resistance value of the semiconductor, thereby reducing the resistance value on the side of the second electrode (4). As a result, loss of the capacitor (25) can be reduced.

### Note 1-2

The chip part (31, 41, 51, 91, 101) according to note 1-1 further includes a penetrating conductive layer (32) that penetrates the semiconductor substrate (2) in a thickness direction to electrically connect the conductive layer (21) to the second electrode (4), wherein a resistance of the penetrating conductive layer (32) is less than a resistance of the semiconductor substrate (2).

According to the configuration, the second electrode (4) can be connected to the conductive layer (21) by the penetrating conductive layer (32) having a resistance lower than that of the semiconductor substrate (2), thereby further reducing loss of the capacitor (25).

### Note 1-3

In the chip part (31, 41, 51, 91, 101) according to note 1-2, a plurality of the penetrating conductive layers (32) are formed in the semiconductor substrate (2).

### Note 1-4

In the chip part (31) according to note 1-3, the plurality of penetrating conductive layers (32) are, in a plan view, arranged in a matrix over an entirety of the first main surface (5) of the semiconductor substrate (2).

### Note 1-5

In the chip part (41) according to note 1-3, the first electrode (3) has a bonding area (33) to which a bonding member (29) is bonded, and the plurality of penetrating conductive layers (32) are collectively formed at a position directly below the bonding area (33).

According to the configuration, the plurality of penetrating conductive layers (32) are gathered directly under the bonding region (33) with a relatively high current density in direct contact with the bonding member (29). Thus, electric charge can be more efficiently stored in the capacitor (25).

### Note 1-6

In the chip part (51) according to note 1-3, the first electrode (3) has a bonding area (33) to which a bonding member (29) is bonded, and the plurality of penetrating conductive layers (32) are selectively formed near an end surface (7 to 10) of the semiconductor substrate (2), avoiding any position directly below the bonding area (33).

According to the configuration, the penetrating conductive layers (32) are formed to avoid positions directly below the bonding area (33). Thus, a force received by the first electrode (3) during bonding of the bonding member (29) is prevented from being directly transmitted to the penetrating conductive layers (32). As a result, strength of the semiconductor substrate (2) can be reinforced.

### Note 1-7

In the chip part (31, 41, 51, 91, 101) according to any of note 1-2 to note 1-6, the penetrating conductive layer (32) includes a conductive via (35) embedded in a through hole (34) penetrating the semiconductor substrate (2) in the thickness direction.

### Note 1-8

The chip part (61, 81, 91, 101) according to any of note 1-1 to note 1-4 includes:

a capacitor trench (62), formed in the first main surface (5) of the semiconductor substrate (2), wherein the conductive layer (21) and the capacitor film (22) form a laminated structure (67) having a boundary surface (66) along an inner surface (65) of the capacitor trench (62): and

an embedded electrode (69), embedded in the capacitor trench (62) through the laminated structure (67) and connected to the first electrode (3).

According to the configuration, the capacitor trench (62) is formed, and hence a facing area between the embedded electrode (69) and the conductive layer (21) can be increased. Thus, a larger capacitance can be ensured for the capacitor (25).

### Note 1-9

In the chip part (81) according to note 1-8, the first electrode (3) has a bonding area (33) to which a bonding member (29) is bonded, and the capacitor trench (62) is selectively formed near an end surface (7 to 10) of the semiconductor substrate (2), avoiding any position directly below the bonding area (33).

### Note 1-10

In the chip part (1, 31, 41, 51, 61, 81, 91, 101) according to any of note 1-1 to note 1-9, the conductive layer (21) covers an entirety of the first main surface (5) of the semiconductor substrate (2).

### Note 1-11

In the chip part (1, 31, 41, 51, 61, 81, 91, 101) according to any of note 1-1 to note 1-10, the conductive layer (21) includes at least one of a metal layer and a polycrystalline silicon (polysilicon) layer.

### Note 1-12

In the chip part (1, 31, 41, 51, 61, 81, 91, 101) according to any of note 1-1 to note 1-11, the semiconductor substrate (2) has a thickness between 80 micrometers (μm) or more and 150 μm or less.

According to the configuration, the thickness of the semiconductor substrate (2) is 80 μm or more and 150 μm or less. Thus, the semiconductor substrate (2) can be provided with a low resistance. As a result, loss of the capacitor (25) can be reduced.

### Note 1-13

In the chip part (1, 31, 41, 51, 61, 81, 91, 101) according to any of note 1-1 to note 1-12, the semiconductor substrate (2) includes a silicon substrate.

### Note 1-14

In the chip part (1, 31, 41, 51, 61, 81, 91, 101) according to any of note 1-1 to note 1-13, the capacitive film (22) has a thickness between 2 μm or more and 8 μm or less.

### Note 1-15

In the chip part (1, 31, 41, 51, 61, 81, 91, 101) according to any of note 1-1 to note 1-14, the capacitive film (22) includes at least one selected from a group consisting of a SiO₂ film, a SiN film, an ON film, an ONO film, an Al₂O₃ film and a Ti₃O₅ film.

1. A chip part, comprising:
a semiconductor substrate, having a first main surface and a second main surface opposite to thefirst main surface;
a capacitive film, disposed on the first main surface;
a first electrode, disposed on the capacitive film;
a second electrode, disposed on the second main surface; and
a conductive layer, disposed between the capacitive film and the semiconductor substrate.

2. The chip part of claim 1, further comprising a penetrating conductive layer that penetrates the semiconductor substrate in a thickness direction to electrically connect the conductive layer to the second electrode, wherein a resistance of the penetrating conductive layer is less than a resistance of the semiconductor substrate.

2. The chip part of claim 2, wherein a plurality of the penetrating conductive layers are formed in the semiconductor substrate.

4. The chip part of claim 3, wherein the plurality of penetrating conductive layers are, in a plan view, arranged in a matrix over an entirety of the first main surface of the semi conductor substrate.

5. The chip part of claim 3, wherein
the first electrode has a bonding area to which a bonding member is bonded, and
the plurality of penetrating conductive layers are collectively formed at a position directly below the bonding area.

6. The chip part of claim 3, wherein
the first electrode has a bonding area to which a bonding member is bonded, and
the plurality of penetrating conductive layers are selectively formed near an end surface of the semiconductor substrate, avoiding any position directly below the bonding area.

2. The chip part of claim 2, wherein the penetrating conductive layer includes a conductive via embedded in a through hole penetrating the semiconductor substrate in the thickness direction.

8. The chip part of claim 3, wherein the penetrating conductive layer includes a conductive via embedded in a through hole penetrating the semiconductor substrate in the thickness direction.

9. The chip part of claim 4, wherein the penetrating conductive layer includes a conductive via embedded in a through hole penetrating the semiconductor substrate in the thickness direction.

10. The chip part of claim 5, wherein the penetrating conductive layer includes a conductive via embedded in a through hole penetrating the semiconductor substrate in the thickness direction.

11. The chip part of claim 1, further comprising:
a capacitor trench, formed in the first main surface of the semiconductor substrate, wherein the conductive layer and the capacitor film form a laminated structure having a boundary surface along an inner surface of the capacitor trench; and
an embedded electrode, embedded in the capacitor trench through the laminated structure and connected to the first electrode.

12. The chip part of claim 2, further comprising:
a capacitor trench, formed in the first main surface of the semiconductor substrate, wherein the conductive layer and the capacitor film form a laminated structure having a boundary surface along an inner surface of the capacitor trench; and
an embedded electrode, embedded in the capacitor trench through the laminated structure and connected to the first electrode.

13. The chip part of claim 3, further comprising:
a capacitor trench, formed in the first main surface of the semiconductor substrate, wherein the conductive layer and the capacitor film form a laminated structure having a boundary surface along an inner surface of the capacitor trench; and
an embedded electrode, embedded in the capacitor trench through the laminated structure and connected to the first electrode.

14. The chip part of claim 11, wherein
the first electrode has a bonding area to which a bonding member is bonded, and
the capacitor trench is selectively formed near an end surface of the semiconductor substrate, avoiding any position directly below the bonding area.

15. The chip part of claim 1, wherein the conductive layer covers an entirety of the first main surface of the semiconductor substrate.

16. The chip part of claim 1, wherein the conductive layer includes at least one of a metal layer and a polycrystalline silicon (polysilicon) layer.

17. The chip part of claim 1, wherein the semiconductor substrate has a thickness between 80 micrometers (μm) and 150 μm.

18. The chip part of claim 1, wherein the semiconductor substrate includes a silicon substrate.

19. The chip part of claim 1, wherein the capacitive film has a thickness between 2 μm and 8 μm.

20. The chip part of claim 1, wherein the capacitive film includes at least one selected from a group including of SiO₂ film, SiN film, ON film, ONO film, Al₂O₃ film and Ti₃O₅ film.
